(19) United States
(12) Patent Application Publication
(10) Pub. No.: US 2022/0285826 A1
(43) Pub. Date: Sep. 8, 2022

(54) ENCLOSURES FOR CELLULAR BASE STATION ASSEMBLIES AND BRACKET ASSEMBLIES FOR MOUNTING SAME

(71) Applicant: CommScope Technologies LLC, Hickory, NC (US)

(72) Inventor: Guilibaldo Ruiz, McKinney, TX (US)

(21) Appl. No.: 17/677,350

(22) Filed: Feb. 22, 2022

Related U.S. Application Data
(60) Provisional application No. 63/156,488, filed on Mar. 4, 2021.

(51) Int. Cl. H01Q 1/24; H01Q 1/12

(52) U.S. Cl. CPC H01Q 1/246; H01Q 1/1242

(57) ABSTRACT

An enclosed antenna-RRU unit includes: an enclosure comprising a front wall, first and second side walls, a floor, a ceiling, and a rear wall; an internal support plate located adjacent the rear wall within the enclosure; an RRU mount plate mounted to the internal support plate; and an antenna-RRU unit housed in the enclosure and mounted to the RRU mount plate.

### RELATED APPLICATION

The present application claims priority from and the benefit of U.S. Provisional Patent Application No. 63/156,488, filed Mar. 4, 2021, the disclosure of which is hereby incorporated herein by reference in full.

### FIELD OF THE INVENTION

The present invention is directed generally toward antennas, and more particularly to mounting structures for antennas.

### BACKGROUND

As wireless data service demands have grown, a conventional response has been to increase the number and capacity of conventional cellular Base Stations (Macro-Cells). The antennas used by such Macro-Cells are typically mounted on antenna towers. A conventional antenna tower has three or four legs on which antennas and supporting remote radio units (RRUs) are mounted, However, in sonic environments structures known as “monopoles” are used as mounting structures. Monopoles are typically employed when fewer antennas/RRUs are to be mounted, and/or when a structure of less height is required.

Macro-Cell sites are becoming less available, and available spectrum limits how much additional capacity can be derived from a given Macro-Cell. Accordingly, small cell RRU and antenna combinations have been developed to “fill in” underserved or congested areas that would otherwise be within a Macro-Cell site. Deployment of small cells, particularly in urban environments, is expected to continue to grow. Often such small cell configurations (sometimes termed “Metrocells”) are mounted on monopoles. Typically, these small cell configurations do not permit mounting of other equipment above the antenna.

In some instances, metrocells may be mounted on existing structures, such as buildings, billboards, kiosks, and the like. See, U.S. Patent Publication No. 2017/0324154 to Hendrix e al. and U.S. Patent Publication No. 2020/0411945 to Heath et al., each of which is hereby incorporated herein by reference in full. In addition, metrocells may be mounted on streetlight poles and the like. See, e.g., U.S. Patent Publication No. 2021/0328337 to Gienger et al., the disclosure of which is hereby incorporated herein in full by references.

When metrocells are deployed in environments where aesthetic appearance is important (or even dictated by local regulation), the components of the metrocell antennas and RRUs) may be concealed from view via external housings and the like. As such, designs have been developed to conceal these components. One exemplary design is shown in FIG. 1, in which an assembly 104) includes a luminaire arm 12 that supports a luminaire 14, an RRU module 15 and an antenna module 16. It can be seen that the RRU and antenna modules 15, 16 are largely concealed and do not extend radially outwardly from the exterior of the underlying pole 10. However, as the configurations and sizes of antennas and RRUs also vary between manufacturers and also change over time, techniques for concealing these components may also require new designs. Thus, it may be desirable to provide additional metrocell concealment arrangements.

### SUMMARY

As a first aspect, embodiments of the invention are directed to an enclosed antenna-RRU unit comprising: an enclosure comprising a front wall, first and second side walls, a floor, a ceiling, and a rear wall; an internal support plate located adjacent the rear wall within the enclosure; an RRU mount plate mounted to the internal support plate; and an antenna-RRU unit housed in the enclosure and mounted to the RRU mount plate.

As a second aspect, embodiments of the invention are directed to a bracket assembly for mounting an antenna-RRU unit to a pole comprising: (a) an antenna bracket comprising a main panel and first and second opposed wings extending from opposed side edges of the main panel, wherein the first wing defines an acute angle with the main panel and the second wing defines an obtuse angle with the main panel; and (b) a pole bracket comprising a central strip, third and fourth wings located on opposite sides of the central strip. First, second, third and fourth mounting features are associated with the first, second, third and fourth wings, wherein the first mounting features engage the third mounting features and the second mounting features engage the fourth mounting features.

### BRIEF DESCRIPTION OF THE FIGURES

FIG. 1 is a front view of an exemplary prior art monopole with a luminaire attached and an antenna module mounted thereon.

FIGS. 2A-2E are front perspective, side, rear perspective, front and top views, respectively, of an enclosure for concealing an antenna-RRU unit according to embodiments of the invention.

FIGS. 3A and 3B are front perspective views of the main body of the enclosure of FIGS. 2A-2E, wherein FIG. 3A shows the main body prior to the formation of the window in the front wall and FIG. 3B showing the main body with the window formed therein.

FIG. 3C is a front exploded perspective view of the main body, the floor and the ceiling of the enclosure of FIGS. 2A-2E.

FIG. 3D is a rear assembled perspective view of the main body, floor and ceiling of the enclosure of FIGS. 2A-2E.

FIGS. 4A-4C are rear perspective views of three different antenna-RRU units with respective RRU mount plates according to embodiments of the invention.

FIGS. 5A and 5B are front and rear perspective views of an internal support plate for mounting the antenna-RRU units of FIGS. 4A-4C in the enclosure of FIGS. 2A-2E.

FIG. 6 is an exploded front perspective view of the enclosure of FIGS. 2A-2E and mounting hardware for mounting the enclosure on the spine of an antenna module.

FIGS. 7A and 7B are top section and front views, respectively of the enclosure of FIGS. 2A-2E with a first size of antenna-RRU unit.

FIGS. 8A and SB are top section and front views, respectively, of the enclosure of FIGS. 2A-2E with a second size of antenna-RRU unit.

FIGS. 9A and 9B are top section and front views, respectively, of the enclosure of FIGS. 2A-2E with a third size of antenna-RRU unit.

FIG. 10A is an assembled perspective view of brackets used to mount the enclosure of FIGS. 2A-2E in a flush manner to the spine of an antenna module.

FIGS. 10B and 10C are exploded and assembled views of the brackets of FIG. 10A and the spine of an antenna module.

FIGS. 11A-11C are rear perspective views of the enclosure of FIGS. 2A-2E attached to a mounting assembly that permits tilting of the antenna-RRU unit.

FIGS. 12A-12D are perspective views of three enclosures mounted on the spine of an antenna module in downtilt, uptilt, level, and flush conditions, respectively.

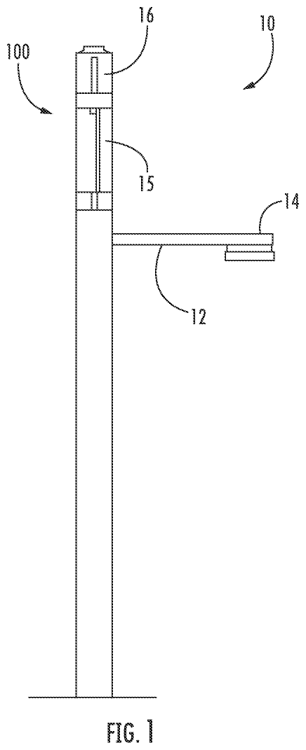

### DETAILED DESCRIPTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

In the figures, certain layers, components or features may be exaggerated for clarity, and broken lines illustrate optional features or operations unless specified otherwise. This invention may, however, be embodied in many different forms and should not be construed as limited to the embodiments set forth herein: rather, these embodiments are provided so that this disclosure will be thorough and complete, and will fully convey the scope of the invention to those skilled in the art.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention. The sequence of operations (or steps) is not limited to the order presented in the claims or figures unless specifically indicated otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

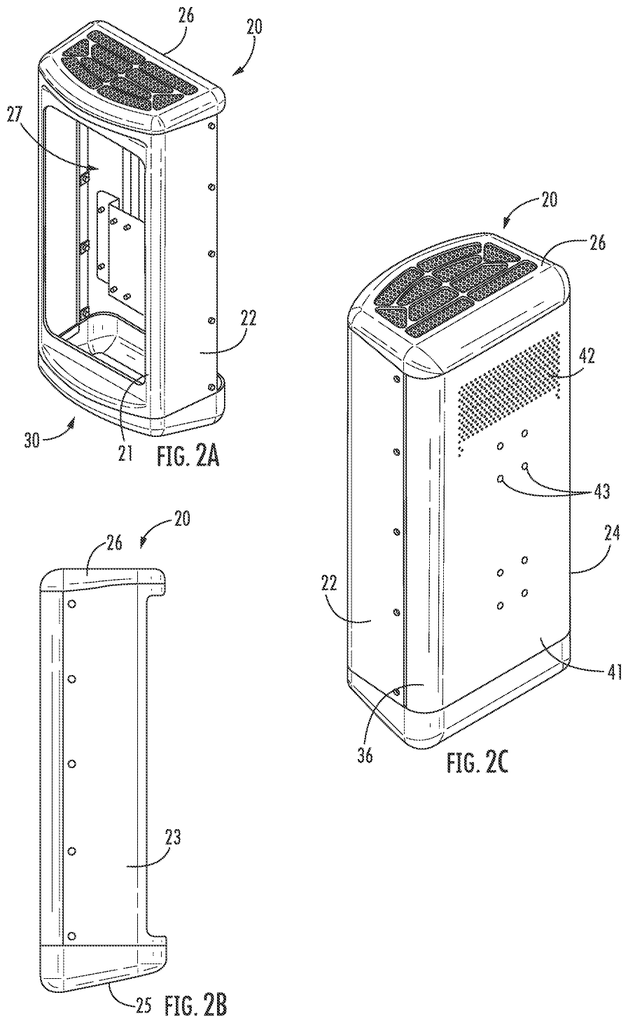

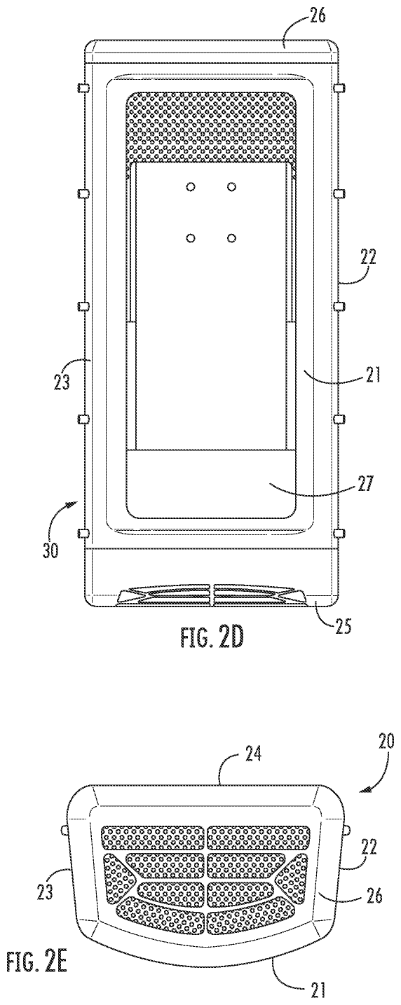

Referring now to the figures, an enclosure for providing concealment to an antenna-RRU unit is designated broadly at 20 and is shown in FIGS. 2A-2E. The enclosure 20 is generally box-shaped, with a front wall 21, side walls 22, 23, a rear wall 24, a floor 25, and a ceiling 26. These are described in greater detail below.

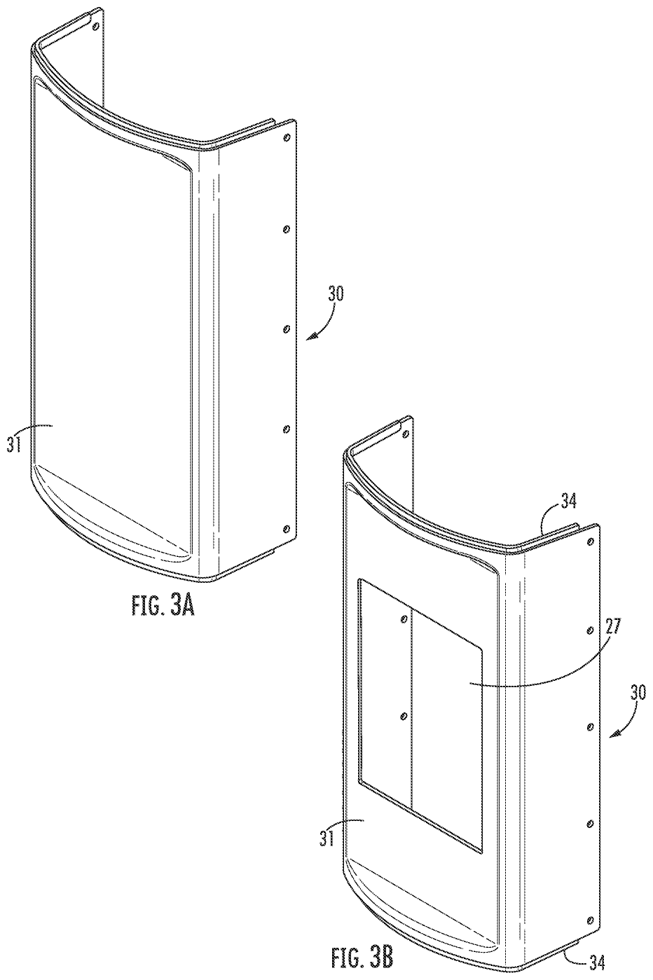

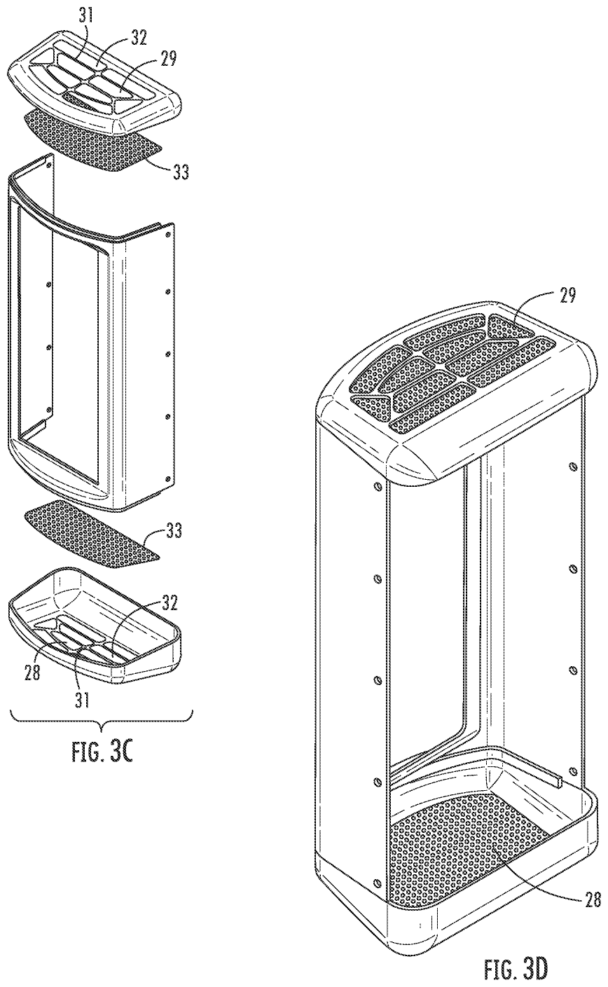

As can be discerned from the figures, a unitary main body 30 may form the front wall 21 and the side walls 22, 23. The front wall 21 includes a window 27 that may be sized for a particular radio. As shown in FIG. 3A, the main body 30 may be formed without the window 27. which can then be cut out of a flat surface 31 of the main body 30 at the appropriate size for the antenna-RRU unit to be housed (see as an example FIG. 3B). It can also be seen that the main body 30 includes a lip 34 on each of its upper and lower edges to facilitate joining with the floor 25 and ceiling 26.

Referring to FIGS. 3C and 3D, each of the floor 25 and the ceiling 26 includes a respective ventilation region 28, 29. Each of the ventilation regions 28, 29 may include a skeletal web 31 with open areas 32, and may have a perforated mesh 33 bonded onto its inner surface to enable the passage of air. Each of the floor 25 and ceiling 26 may have a flange to mate with the lips 34 of the main body 30.

The math body 30, the floor 25 and the ceiling 26 may be formed of a polymeric material, such as acrylonitrile-butadiene-styrene (ABS). These components may be attached to each other in any manner known to be suitable for joining polymeric parts, such as ultrasonic welding, adhesives, or the like. The lips 34 and the flanges of the floor 25 and ceiling 26 may be configured and/or include features to facilitate bonding, and/or a gasket or O-ring to promote sealing.

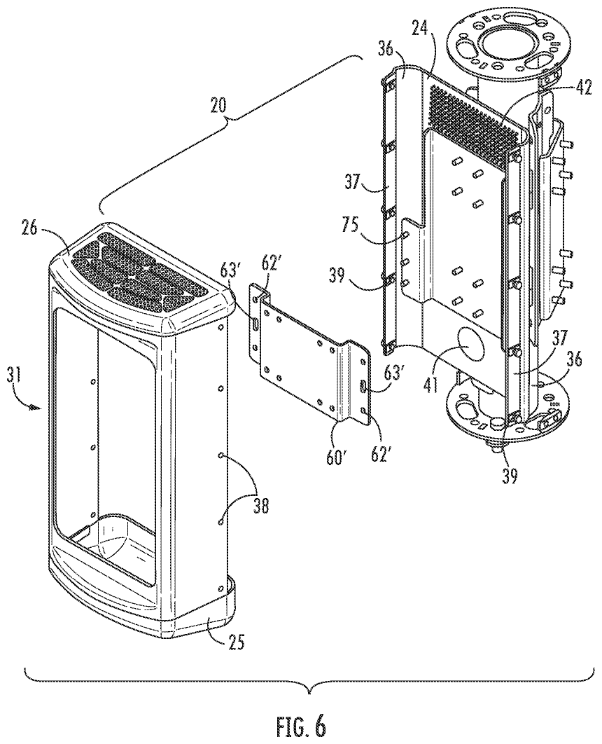

The rear wall 24 is typically formed. of a metallic material, such as stainless steel, to provide a stable mounting location. As can be seen in FIGS. 2C and 6, the rear wall 24 is generally flat, but has side portions 36 that extend forwardly to meet the rear edges of the side walls 22., 23, and slightly inset flanges 37 that extend forwardly of the side portions 36 to fit inwardly of the side walls 22, 23. The rear wall 24 may be attached to the side walls 22, 23 via fasteners inserted through holes 38 in the side walls 22, 23 and holes 39 in the inset flanges 37. The rear wall 24 also includes a knockout area 41 that can provide access for routing cables into the enclosure 20, a ventilation region 42 near its upper end, and eight mounting holes 43 arranged in two square patterns.

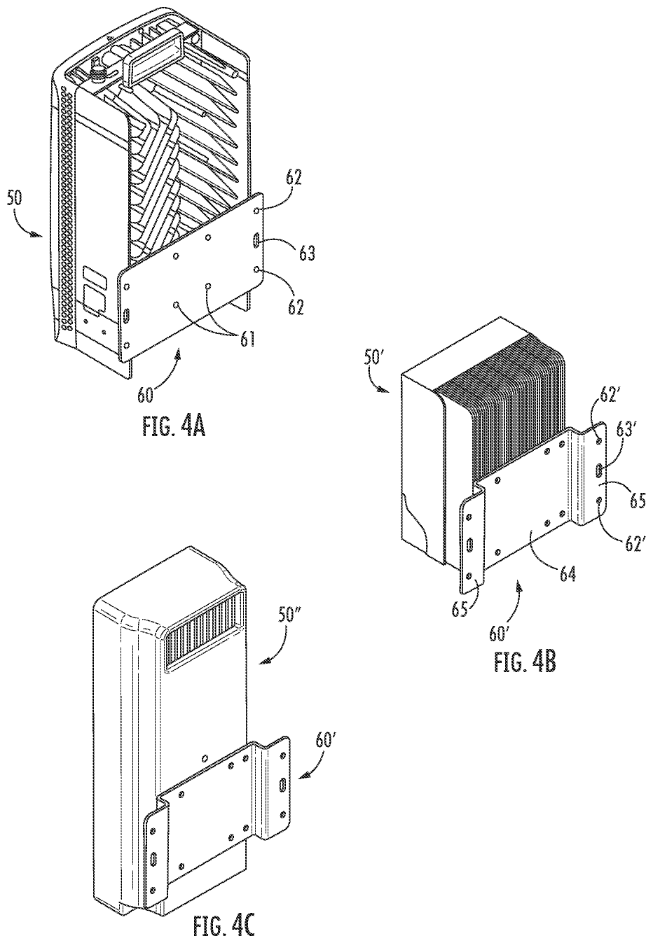

FIGS. 4A-4C illustrate three different exemplary antenna-RRU units 50, 50′, 50″ that may be housed in the enclosure 20. The antenna/RRU units 50, 50′, 50″ are “active-antenna” units, meaning that they are antenna-radio units that comprise both a transmit/receive radio and an antenna in the same unit. The illustrated antenna-RRU units 50, 50′, 50″ are “5G” units, which are devices that meet the requisite high level of performance and precision to satisfy 5G protocols and performance requirements. Exemplary antenna-RRU units include Model No. At1K0X (available from Nokia—illustrated as antenna-RRU unit 50), Model No. 1281 (available from Ericsson—illustrated as antenna-RRU unit 50′), and Model No. 6701 (also available from Ericsson—illustrated as antenna-RRU unit 50″).

FIGS. 4A-4C also illustrate two different RRU mount plates 60, 60′ that may be employed in the mounting of the antenna-RRU units 50, 50′, 50″. The RRU mount plate 60, used to mount the antenna-RRU unit 50, is a flat plate that includes four mounting holes 61 in square pattern near its center, and includes two mounting holes 62 that sandwich an oblong vertical slot 63 at each side edge. The RRU mount plate 60′ has a flat main panel 64 with two wings 65 that are parallel to but offset rearwardly from the main panel 64. The main panel 64 includes eight mounting holes 66 (two in each corner of the main panel 64), and also includes two mounting holes 62′ and a slot 63′ in each wing 65 that are arranged in the same manner as the mounting holes 62 and slot 63 of the RRU mount plate 60.

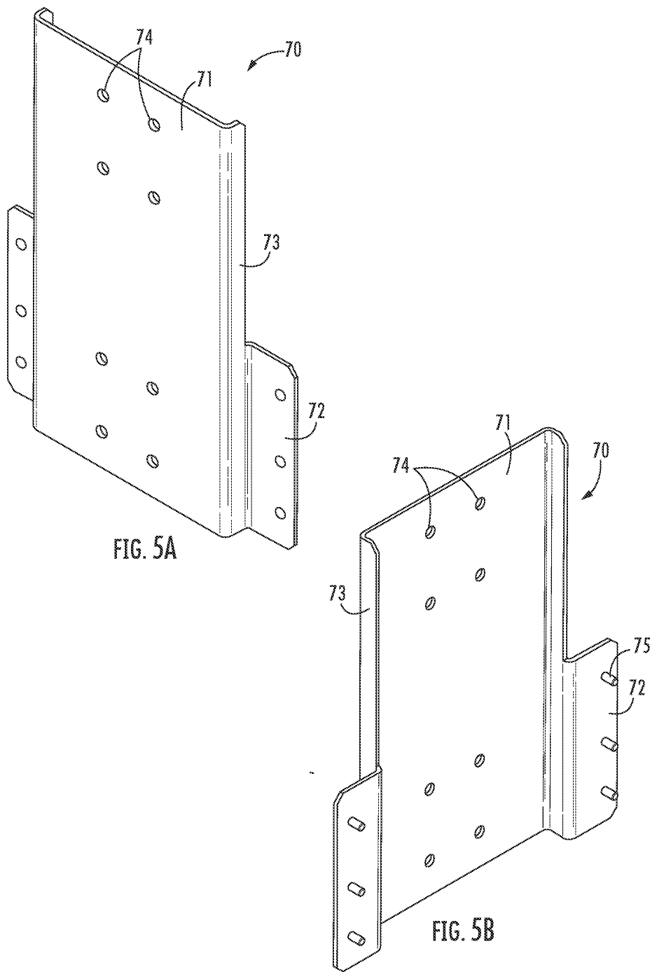

FIGS. 5A and 5B illustrate an internal support plate 70 that may be employed in the mounting of the antenna-RRU units 50, 50′, 50″. The internal support plate 70 includes a main panel 71 and two wings 72 that are parallel to but forwardly offset from the main panel 71. Transitions sections 73 line the side edges of the main panel 71. Eight mounting holes 74 are present in the main panel 71 and are arranged in two square patterns that match those of the mounting holes 43 of the rear wall 24. Three bolts or threaded rods 75 extend forwardly from each of the wings 72; the bolts 75 are arranged in a vertical line.

As shown in FIG. 6, the internal support plate 70 is mounted inside of the enclosure 20 (specifically in front of the rear wall 24). One of the RRU mounting plates 60, 60′ (the RRU mounting plate 60′ is shown in FIG. 6) is then mounted to the internal support plate 70 via the bolts 75 being inserted into the mounting holes 62′ and the slots 63′.

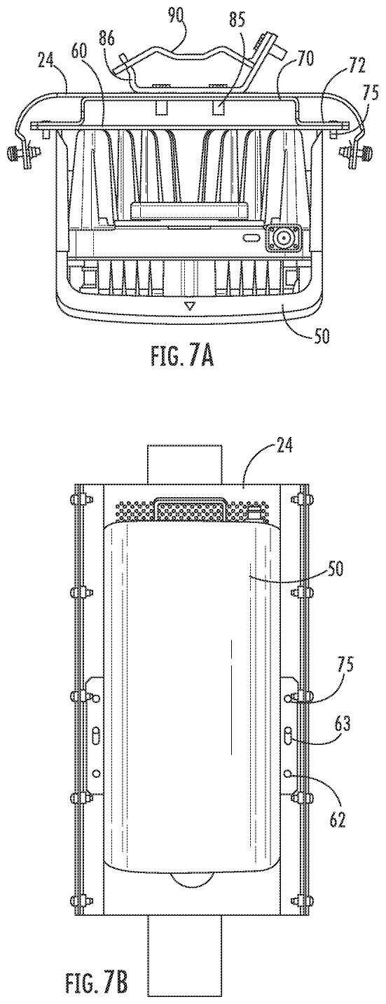

FIGS. 7A-9B illustrate the mounting of antenna-RRU units 50, 50′, 50″ within the enclosure 20. FIGS. 7A and 7B illustrate the mounting of the antenna-RRU unit 50 in the enclosure 20. As can be seen in FIG. 7A, the wings 72 of the internal mounting plate 70 overlie the outer edges of the RRU mount plate 60, such that the bolts 75 may be inserted through the mounting holes 62 and slot 63 to attach the internal mounting plate 70 and the RRU mount plate 60. The RRU 50 can be mounted to the RRU mount plate 60 via bolts or other fasteners inserted through the mounting holes 61 (not shown in FIG. 7A). The rear wall 24 is attached to a rear side of the internal support plate 70 via bolts or other fasteners 85 associated with an antenna bracket 80 and a pole bracket 90, which are discussed in detail below. The main body 30, the floor 25 and the ceiling 26 can then be attached to the rear wall 24 to complete the enclosure 20. The front of the antenna-RRU unit 50 is substantially flush with the portion of the front wall 21 surrounding the window 27.

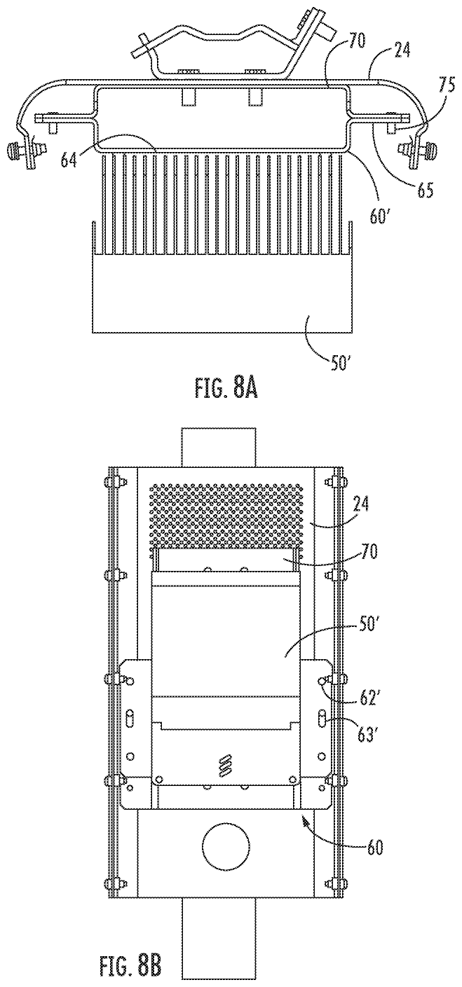

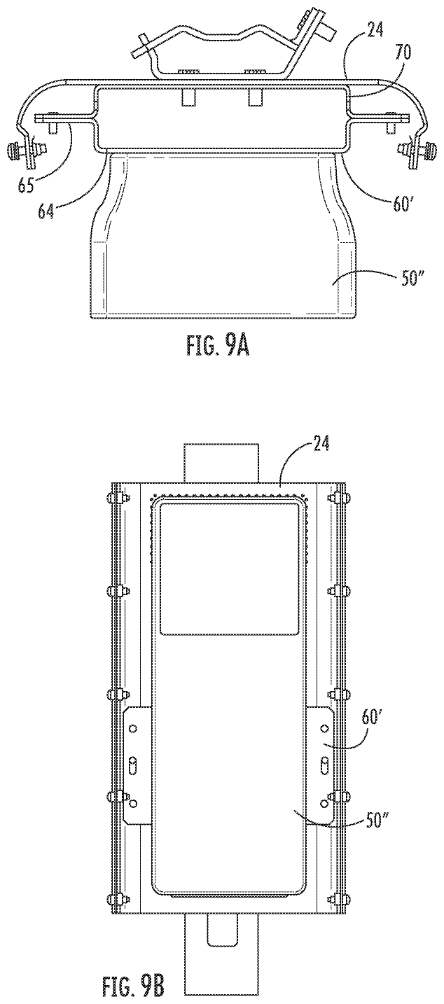

FIGS. 8A and 8B illustrate the mounting of the antenna-RRU unit 50′ within the enclosure 20. This mounting utilizes the RRU mounting plate 60′, which mounts to the internal support plate 70 via the bolts 75 inserted into the mounting holes 62′ and slots 63′. Notably, the RRU mounting plate 60′ is oriented so that the main panel 64 is forward of the wings 65. The rear wall 24 is attached to the internal support plate 70 as described above. FIGS. 9A and 9B illustrate the mounting of the antenna-RRU unit 50″ within the enclosure 20 utilizing the mounting plate 60′ in the same manner. As described above in connection with the antenna-RRU unit 50, the antenna-RRU units 50′, 50″ are mounted in the enclosure 20 such that the front of each unit is substantially flush with the portion of the front wall 21 surrounding the window 27. This positioning is due to the offset of the wings 65 from the main panel 64 of the RRU mounting plate 60′ (the antenna-RRU units 50′, 50″ are narrower from front-to-back than the antenna-RRU unit 50).

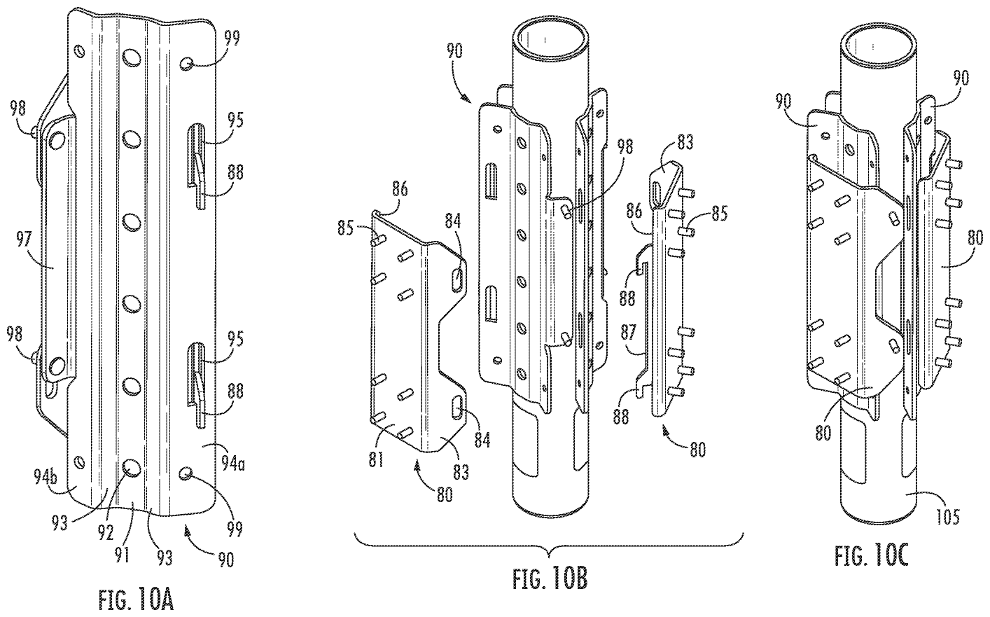

Referring now to FIGS. 10A-10C, the aforementioned antenna bracket 80 and pole bracket 90 are shown therein. Referring first to FIG. 10B, the antenna bracket 80 includes a main panel 81 with eight holes for bolts 85 arranged in two square patterns that match the mounting holes 43 in the rear wall 24. One wing 83 extends rearwardly from a side edge of the main panel 81 at an obtuse angle (typically between about 105 and 135 degrees). Two vertical slots 84 are located in the wing 83. A second wing 86 extends rearwardly horn the opposite side edge of the main panel at a generally right angle. A hook panel 87 with two hooks 88 extends rearwardly and outwardly from the wing 86.

FIG. 10A illustrates the pole bracket 90. The pole bracket 90 includes a central strip 91 that includes a plurality of mounting holes 92. A transition strip 93 is attached to each of the side edges of the central strip and extends at an obtuse angle thereto. Wings 94a, 94b are attached to respective edges of the transition strips 93 and extend at an angle thereto. The wing 94a includes two vertical slots 95 positioned to receive the hooks 88 of the antenna bracket 80. The wing 94b includes two mounting holes 96. A flange 97 extends from the wing 94b. Two bolts, pins or other projections 98 extend forwardly and outwardly from the flange 97. Each of the wings 94a, 94b includes two mounting holes 99.

As shown in FIGS. 10A-10C, three pole brackets 90 can be mounted to a pole 105. Each of the pole brackets 90 is arranged with its central strip 91 and transition strips 93 wrapping partially around the pole 105, as the pole 105 fits within a concave pocket formed by central strip 91 and the transition strips 93. The pole brackets 90 may be secured to the pole 90 via fasteners inserted through the holes 92 in the central strip 91, and/or by bolts or threaded rods 106 inserted through the mounting holes 99 in the wings 94a, 94b of adjacent pole brackets 90. An antenna bracket 80 can then be mounted on a respective pole bracket 90 by inserting the hooks 88 into the slots 95 of the wings 94a, and inserting the bolts or pins 98 through the slots 84 in the wing 83. The bolts 85 are then inserted through the holes 43 in the rear panel 24 of the enclosure 20 and the mounting holes 74 of the internal support plate 70. As shown in FIG. 6, the antenna-RRU unit 50, 50′, 50″ and its corresponding RRU mount plate 60, 60′ are mounted to the internal support plate 70, and the main body 31, floor 25 and ceiling 26 are mounted onto the rear wall 24. In this manner, all three enclosures 20 can be mounted essentially “flush” with the pole 105. (In some embodiments, the pole 105 may be part of the foundation of an antenna module such as those described above).

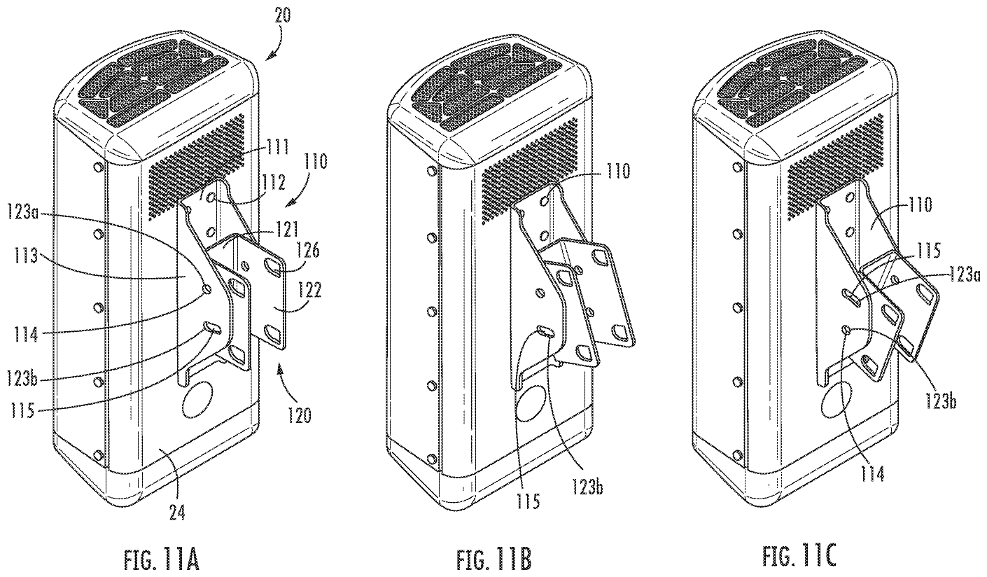

In some embodiments, it may be desirable to mount the enclosure 20 and antenna-RRU unit 50, 50′, 50″ mounted therein so that the antenna-RRU unit 50, 50′, 50″ may be tilted up or down. In such an instance, and referring to FIGS. 11A-11C, an antenna bracket 110 comprising a main panel 111 with mounting holes 112 and side panels 113 is mounted to the rear wall 24 and internal support panel 70 in the manner described above (i.e., fasteners are inserted through the mounting holes 112 into the mounting holes 43 and 74). Each of the side panels 113 has a hole 114 and a generally horizontal slot 115. A tilt bracket 120 has a central panel 121 and side panels 122. Each side panel 122 has pins 123a, 123b that are positioned to be inserted into the hole 114 and slot 115 of an attached antenna bracket 110. Each side panel 122 also includes holes 126 in its upper and lower corners. The holes 126 are configured to receive a mounting band (such as a band clamp or hose clamp) that is routed through the holes 126 of the three tilt brackets 120 for three different antenna-RRU units to mount them to a pole 105. (Alternatively, the hose clamps can be employed to mount only one or two of the antenna-RRU units to the pole 105).

As seen in FIG. 11A, for a zero-tilt antenna, the antenna bracket 110b is oriented for mounting with the hole 114 above the slot 115. The pin 123a of the tilt bracket 120 fits in the hole 114, and the pin 123b fits in the slot 115 and resides in the forward end of the slot 115. For an uptilted antenna (FIG. 11B), the orientation of the antenna bracket 114) is the same, but the pin 123b is positioned at the rear end of the slot 115. For a downtilted antenna (FIG. 11C), the antenna bracket 110 is mounted to the rear wall 24 inverted from the orientation described above, such that the slots 115 are above the holes 114. The pin 123b is received in the hole 114, and the pin 123a is received in the slot 115 and positioned in the rear end thereof. Thus, the same combination of antenna bracket 110 and tilt bracket 120 may be used for any of the three positions.

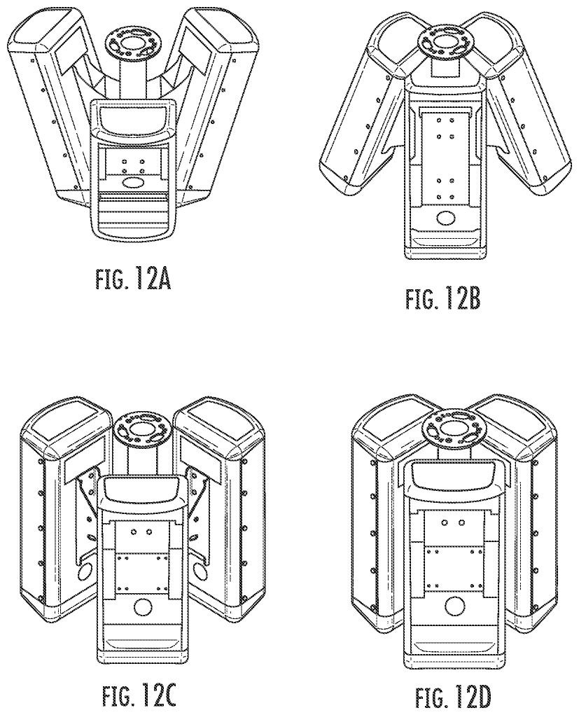

The four different deployment positions described above are shown in FIGS. 12A-12D: downtilted (FIG. 12A), uptilted (FIG. 12B), zero-tilt (FIG. 12C), and flush mounted (FIG. 12D). In all of these deployments, the inclusion of the internal support plate 70 on the interior of the enclosure 20 enables three antenna-RRU units 50, 50′, 50″ to be mounted with a relatively small footprint. In addition, the capability of using the same internal support plate 70 with different antenna-RRU units (even those from different manufacturers) can simplify manufacturing and reduce manufacturing costs. Similarly, the capability of using only two different RRU mounting plates 60, 60′ to mount three different antenna-RRU units can further simplify manufacturing and lower costs.

Those of skill in this art will appreciate that the components and assemblies discussed herein may take different forms. For example, the enclosure 20 may be farmed of more or fewer separate pieces. In some instances the window 27 in the front wall 21 may be formed as the front wall 21 itself is formed (rather than being cut out in a later operation). The antenna-RRU units may be mounted to project forwardly of the front wall 21 rather than being mounted flush. Other variations may also be suitable.

In addition, the RRU mount plates 60, 60′ may take different configurations, as may the internal support plate 70. For example, in some embodiments, these components may be combined as a single integrated unit.

It will also be understood that the antenna bracket 80 and/or pole bracket 90 may take different configurations. For example, the hooks 88 of the antenna bracket 80 and the slots 95 of the pole bracket 90 may be reversed, as may the slots 84 of the antenna bracket 80 and the pins/bolts 98 of the pole bracket 90. The hooks 88, pins/bolts 98 and/or the slots 84, 95 may be replaced with other mounting features. Other alternatives may also be feasible.

Further, the configurations of the antenna bracket 110 and the tilt bracket 120 may vary. As one example, the tilt bracket 120 may take a configuration similar to the antenna bracket 80, which would enable it to be mounted on a pole using a pole bracket 90. Other variations may also be suitable for use in connection with embodiments of the invention.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed is:

1. An enclosed antenna-RRU unit, comprising:
an enclosure comprising a front wall, first and second side walls, a floor, a ceiling, and a rear wall;
an internal support plate located adjacent the rear wall within the enclosure;
an RRU mount plate mounted to the internal support plate; and
art antenna-RRU unit housed in the enclosure and mounted to the RRU mountplate.

2. The enclosed antenna-RRU unit defined in claim 1, wherein the front wall and the first and second side walls are formed as an integral main body.

3. The enclosed antenna-RRU unit defined in claim 2, wherein the front wall includes a window, the window being cut into a flat area of the main body.

4. The enclosed antenna-RRU unit defined in claim 2, wherein the main body is formed of a polymeric material, and the rear wall is formed of a metallic material.

5. The enclosed antenna-RRU unit defined in claim 1, wherein the RRU mount plate is a flat plate.

6. The enclosed antenna-RRU unit defined in claim 1, wherein the RRU mount comprises a main panel and opposed lateral wings that are parallel to but rearwardly offset from the main panel.

7. The enclosed antenna-RRU unit defined in claim 1, wherein the internal support plate comprises a main panel and opposed lateral wings that are parallel to but forwardly offset from the main panel.

8. The enclosed antenna-RRU unit defined in claim 1, further comprising an antenna bracket mounted to the rear wall and to the internal support plate.

9. The enclosed antenna-RRU unit defined in claim 8, wherein the antenna bracket is pivotally mounted to a tilt bracket.

10. The enclosed antenna-RRU unit defined in claim 8, wherein the antenna bracket is fixed to a pole bracket.

11. The enclosed antenna-RRU unit defined in claim 1, wherein the floor includes a ventilation area, and the ceiling includes a ventilation area.

12. A bracket assembly for mounting an antenna-RRU unit to a pole, comprising:
(a) an antenna bracket comprising a main panel and first and second opposed wings extending from opposed side edges of the main panel, wherein the first wing defines an acute angle with the main panel and the second wing defines an obtuse angle with the main panel; and
(b) a pole bracket comprising a central strip, third and fourth wings located on opposite sides of the central strip;
wherein first, second, third and fourth mounting features are associated with the first, second, third and fourth wings, wherein the first mounting features engage the third mounting features and the second mounting features engage the fourth mounting features.

13. The bracket assembly defined in claim 12, wherein the first wing includes a first flange, and wherein the first mounting feature is located on the first flange.

14. The bracket assembly defined in claim 13, wherein the first mounting feature is a hook, and wherein the third mounting feature is a vertical slot.

15. The bracket assembly defined in claim 12, wherein the fourth wing includes a second flange, and wherein the fourth mounting feature is located on the second flange.

16. The bracket assembly defined in claim 15, wherein second mounting, feature is a slot, and wherein the fourth mounting feature is a projection from the second flange.

17. The bracket assembly defined in claim 12, wherein the pole bracket further comprises transition strips between the central strip and the third and fourth wings, and wherein the central strip and the transition strips form a concave pocket that is configured to receive the outer surface of the pole.

18. The bracket assembly defined in claim 12, wherein the main panel includes mounting, holes for an antenna enclosure.

19. A combination comprising:
first, second and third bracket assemblies as defined in claim 12, mounted to a pole.

20. The combination of claim 19, further comprising an antenna-RRU unit mounted to each of the first, second and third bracket assemblies.
